(19) United States
(12) Patent Application Publication
(10) Pub. No.: US 2014/0149199 A1
(43) Pub. Date: May 29, 2014

(54) METHOD FOR A CHEATING-PROOF USER EXPERIENCE BASED LOYALTY PROGRAM AND A COMPUTER PROGRAM PRODUCT FOR ASSIGNING LOYALTY POINTS TO USERS

(71) Applicant: TELEFONICA, S. A., Madrid (ES)

(72) Inventors: Rodrigo de OLIVEIRA, Madrid (ES); Mauro CHERUBINI, Madrid (ES)

(73) Assignee: TELEFONICA, S.A., Madrid (ES)

(21) Appl. No.: 13/684,918

(22) Filed: Nov. 26, 2012

(51) Int. Cl. G06Q 30/02

(52) U.S. Cl. CPC G06Q 30/0226
USPC 705/14.33; 705/14.27

(57) ABSTRACT

Method for a cheating-proof user experience based loyalty program and a computer program product for assigning loyalty points to users.

The method assigning loyalty points to users complying with a target behavior when using a device, the method performing the following steps:
logging a first set of user self-reported behavior data relating to the use of said device;
logging a second set of automatically recorded user behavior data and assigning a trustfulness index to said data recorded; and
when said trustfulness index is lower than a predetermined value, generating a first comparison value comparing said self-reported behavior to predefined target behavior data of said device , and assigning loyalty points to the user according to said first comparison value; and when is equal or higher, generating a second comparison value comparing said second set of automatically recorded user behavior data to said predefined target behavior data for assigning loyalty points to the user; and generating a third comparison value related to comparing said first set of user self-reported behavior data and said second set of automatically recorded user behavior data, for assigning extra loyalty points to said user.

### FIELD OF THE ART

The present invention relates to a method for customers' loyalty programs, and more particularly to a method for a cheating-proof user experience based loyalty program.

The invention in a second aspect also relates to a computer program product for assigning loyalty points to users.

### PRIOR STATE OF THE ART

Customers' loyalty programs have a strong role in driving sales. These are usually carried out by means of redemption of proof of purchases and collection of virtual points each time a customer makes a purchase of a specific kind. The typical way a loyalty program works is the following: the program is advertised through different channels (e.g., TV, or the package of the goods, etc.); the customer buys the good and collects the proof of purchase or the virtual credit associated to a customer ID; once the customer has collected enough points or coupons, they can be exchanged for a prize/coupon/discount at the shop or through a dedicated service (e.g. sent through mail).

The major limitation of current loyalty programs is that they are usually completely disjoint from the customers' experience with the product. For instance, a customer buys a glass cleaner spray and then uses the product to clean a table made of wood, hence using the product improperly. Similarly, a customer might use the wrong amount of laundry washing powder, obtaining suboptimal results with the product and/or potentially polluting the environment and wasting the product. Currently, many products such as the ones in these examples have loyalty programs that entitle their customers to obtain rewards based on the act of purchase only, even if they have been used improperly. In short, rewards associated with traditional loyalty programs are commonly not related to the use that people make of the products they buy. This disassociation can have negative consequences for the consumer (e.g. poor satisfaction with the product), the manufacturer (e.g. lower sales, higher customer support demand) and the environment (e.g. pollution).

Proposing a user experience based loyalty program requires however a reliable procedure for monitoring the customer's behavior with the product. In some cases this procedure can be automated using a trusted method (e.g. automatically detecting smartphone falls using a mobile application developed by the manufacturer that monitors the phone's internal accelerometer sensor). However, even in these cases the trusted method might be exposed to situations that prevent it from collecting reliable data (e.g. when the phone is exposed to high frequency electromagnetic interference) or from getting any data at all (e.g. reading phone-sensed data when the phone is off). Some have tried asking customers to self-report their behavior and then assigning loyalty points based on their reports [2]. This approach was proved to be sensitive to cheating, as users try to tamper the system reporting only their appropriate behavior with the product, even when such compliant behavior never happened [1].

It is then of great importance to create a loyalty program that takes the users' experience into account while also enabling trustful customer behavior logging. There exist some related patent in the field of medication compliance related to this issue. For instance, patent application US 2011201421 ‘Medication Compliance Using Persuasive Computing’ described a method for encouraging a user to comply with his/her medication regimen. The method registering a group of parameters related to a medication intake of said user, computing then a time difference between said time parameter received and a time parameter associated to said user identifier previously recorded in a server; assigning said user with a pre-established number of points depending on the value of said time difference; and providing said user with information regarding his/her points obtained for the medication intake.

Patent application WO 2008039728 ‘Systems and Methods for Improving Medication Adherence’ is related to simple systems and methods for inducing patients to take their medications, without the need for outside prompting, and without the need for electronic medication dispensers. Instead, use simple medication dispensers with unique markings to motivate the patients to take their medications based on voluntary actions to obtain a reward, e.g., an intermittent reward. In addition, the new systems and methods allow the collection of user data, all volunteered by the users.

On another hand, patent application WO 2008089084 ‘Behavior Modification with Intermittent Reward’ described effective methods, referred to Dynamic Intermittent Reward (DIR), and systems, to increase the frequency of a desired behavior in a user, and optimize cost-effectiveness of a reward system.

The object of the present invention is to provide a loyalty program solution that takes into account the consumer's experience with the product he or she buys, while also enabling trustful customer behavior logging for the point-assignment scheme.

### SUMMARY OF THE INVENTION

In accordance with this invention, the previous objective is obtained, in a first aspect, by providing a method for a cheating-proof user experience based loyalty program, comprising assigning loyalty points to users complying with a target behavior when using a device with an electronic component.

The method in a characteristic manner and on contrary of the known proposals comprising following steps:
logging by a user a first set of user self-reported behavior data relating to the use of said device within a period of time;
logging by said device a second set of automatically recorded user behavior data relating to said same period of time obtained from an interaction with said device, and assigning a trustfulness index to said data recorded by said automatic behavior data recording; and

a) when said trustfulness index is lower than a predetermined value, generating a first comparison value comparing said self-reported behavior to a predefined user target behavior data of said device within said period of time , and assigning loyalty points to the user according to said first comparison value; and

b) when said trustfulness index is equal or higher than said predetermined value, generating a second comparison value comparing said second set of automatically recorded user behavior data to said predefined target behavior data, and assigning loyalty points to the user according to said second comparison value; and generating a third comparison value related to comparing said first set of user self-reported behavior data and said second set of automatically recorded user behavior data, and assigning extra loyalty points to said user according to said third comparison value.

In embodiments, both the loyalty and extra loyalty points can attain positive or negative values. However, preferred embodiments refer to positive values. In particular, if the absolute value of the third comparison value is greater than a cheating-detection predetermined value, no extra loyalty points are added to said user; and if the absolute value of the third comparison value is lower than or equal to a cheating-detection predetermined value, extra loyalty points are added to said user.

The user preferably doesn't know the content of said second set of automatically recorded user behavior data. Furthermore, said automatic logging trustfulness index is also kept unknown to said user.

The user, in an embodiment, can define the preferred reporting frequency of said user self-reported behavior data.

The electronic component of the invention can be any monitoring device, such as a thermometer, an accelerometer, a magnetometer, a global positioning system, a heart rate monitor, a mobile device among any other. In general, said electronic component can be inside the device, attached thereon or it can be separated from the device that it is monitoring.

The user self-reported behavior data is provided to a server by using said device or any other computing device through a communication network and/or through any mobile messaging technology, i.e. SMS or MMS. The interaction between the server and the electronic component is also done through a communication network and/or through any mobile messaging technology.

Moreover, in yet another embodiment, the automatically recorded user behavior data can be recorded in a memory of said device and/or in any auxiliary device prior to performing said interaction.

Finally, when the target points are met said user can be provided with a prize and/or a good.

The present invention in a second aspect relates to a computer program product for assigning loyalty points to users complying with a predefined user target behavior data when using a device with an electronic component adapted to assigning a trustfulness index to a set of automatically recorded user behavior data relating to a period of time obtained from an interaction with said device, the computer program product comprising:
software code that is configured to, when said trustfulness index is lower than a predetermined value, generate a first comparison value comparing a self-reported behavior of said user to predefined target behavior data defined by a manufacturer of said device and assigning loyalty points to the user according to said first comparison value; and
software code that is configured to, when said trustfulness index is equal or higher than said predetermined value, generate a second comparison value comparing said second set of automatically recorded user behavior data to said target behavior and assigning loyalty points to the user according to said second comparison value; generate a third comparison value related to comparing said second set of automatically recorded user behavior data and said first set of user self-reported behavior data, and assigning extra loyalty points to said user according to said third comparison value.

The computer program product further comprises, in an embodiment, software code that is configured to, when the absolute value of the third comparison value is greater than a cheating-detection predetermined value, add no extra loyalty points to said user; and when the absolute value of the third comparison value is lower than or equal to a cheating-detection predetermined value, add extra loyalty points to said user.

### BRIEF DESCRIPTION OF THE DRAWINGS

The previous and other advantages and features will be more fully understood from the following detailed description of embodiments, with reference to the attached, which must be considered in an illustrative and non-limiting manner, in which:

FIG. 1 is an illustration showing the interaction flow of the proposed loyalty program.

FIG. 2 is a flow chart showing the Loyalty program cheating-proof mechanism for the customer behavior logging.

### DETAILED DESCRIPTION OF SEVERAL EMBODIMENTS

The present invention uses a simple reasoning for assigning loyalty points to customers: if the customer uses the product according to the target behavior that has been defined by the manufacturer at the fabrication time of the product and/or at the purchasing time for instance, then the manufacturer's customer (loyalty) points are accrued to the customer; if the customer however does not comply with the target behavior, then s/he wins few or no points. Assigning points that can be later exchanged for goods to customers that achieve a particular target behavior is used in the present invention as a motivational scheme leveraging persuasive techniques.

It also includes a number of steps to assign loyalty points to customers based on how accurately they use a certain product.

The point assignment scheme relies primarily on data gathered intermittently by the automatic behavior logging method trusted by the product manufacturer. For instance, a smartphone maker could sense the customer's smartphone falls by using data gathered from the phone's internal accelerometer sensor. In addition, customer self-reported behavior with the product is also collected intermittently and compared to the trusted method as following: every time the customer reports his/her actual behavior, and if it matches data collected by the trusted automatic method, extra loyalty points are assigned to the customer; otherwise, s/he loses the opportunity to earn extra bonus points. Given that loyalty points are primarily assigned based on data collected by the automatic method, the customer shall feel persuaded to always tell the truth about his/her behavior in order to receive extra points, even when that means reporting an inadequate behavior with the given product. This creates the basis for the cheating-proof mechanism: whenever the automatic method fails, the loyalty program can safely trust the customer's self-reported behavior as s/he will not know that the automatic method failed and hence will likely continue telling the truth about his/her behavior to earn extra bonus points.

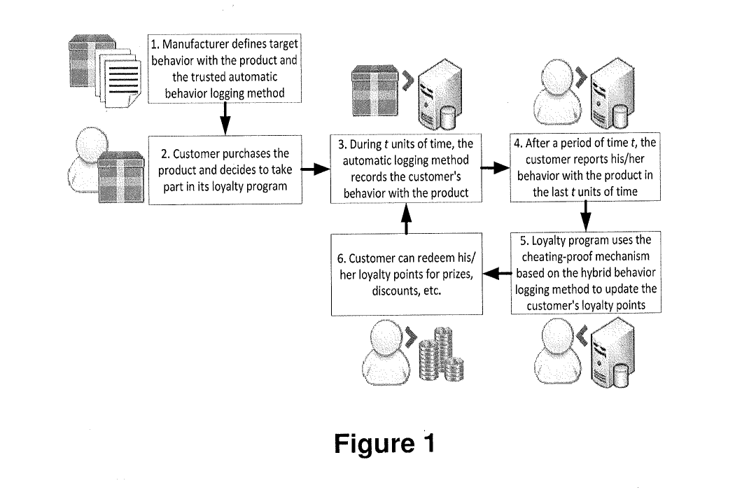

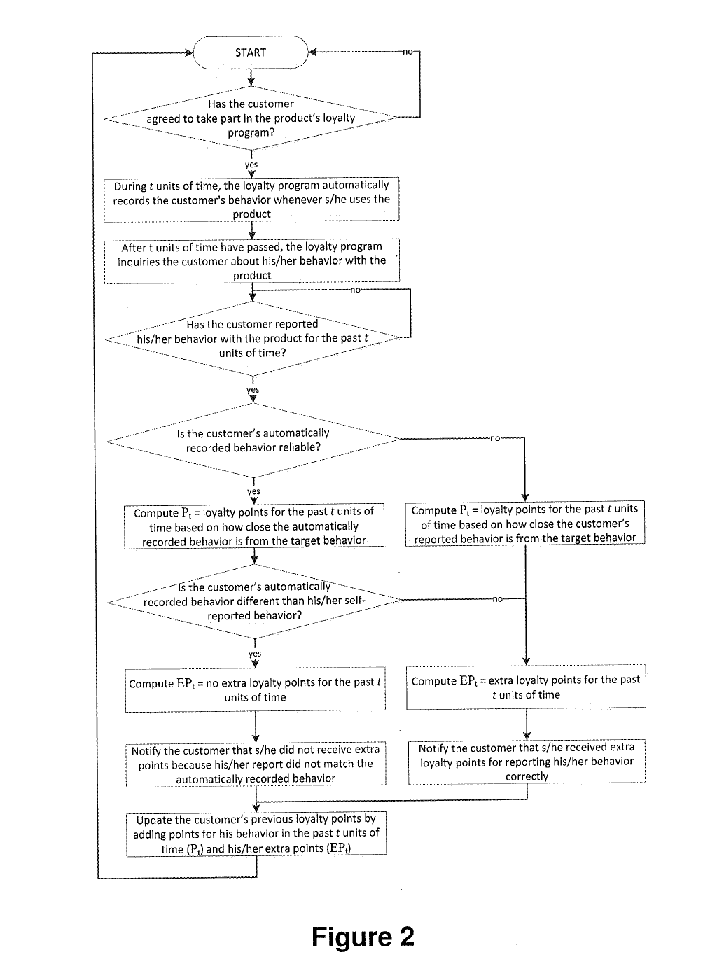

With reference to FIGS. 1 and 2, the main steps to assign loyalty points are:
1. Definition of the customer's target behavior and the trusted automatic behavior logging method: The product manufacturer defines a set of behavior parameters with respect to the said product that explains how customers should use it. Furthermore, the manufacturer defines an automatic method for logging customers' behavior with the product. Whenever customers use the product, this method should be enabled and record parameters related to how the product is being used. The closer customers' behavior is to the given parameters—as captured by the automatic logging method, the more points they should receive in the loyalty program. In this first step, the manufacturer can also define how often (t units of time) it would like to collect customer behavior reports. Other possible implementations of the proposed loyalty program could involve customers in this decision by letting them suggest their preferred report frequency.
2. Product purchase and agreement to participate in the loyalty program: The customer learns the rules of the program that include an explanation of the target behavior that consumers need to comply with in order to accrue loyalty points. Participation in the program is totally voluntary. This step can happen after the customer's decision to buy the product. Products can be assigned a unique identifier depending on how much control over the consumers' behavior the manufacturer is interested in collecting. Assigning unique identifiers to each product sold could help the manufacturer better track sales and prevent users from tampering the point assignment scheme.
3. Trusted automatic behavior logging: The consumer uses the product and his/her usage behavior is recorded automatically by the trusted method as defined by the manufacturer (see step 1). This method can leverage different monitoring devices, such as a thermometer, accelerometer, magnetometer, global positioning system, heart rate monitor, among others. Behavior logs could be temporarily stored in the product's memory or in any auxiliary device, and later recorded on a remote and secure dedicated service (e.g. database server). Transmission can be achieved through the Internet or through other mobile messaging technologies such as SMS or MMS.
4. Customer self-reported behavior logging: After a period of time t (preferably defined by the manufacturer—see step 1) has passed since the last customer's behavior report, the loyalty program probes the customer asking about his/her behavior with the product in the last t units of time. Customers can be probed using online surveys, call centers, among other approaches. Questions should be related to the target behavior as originally defined by the manufacturer (see step 1). Answers could be provided in a number of ways, including multiple-choice or free text answers, among others.
5. Cheating proof-mechanism for point assignment: Customer behavior logs obtained with the hybrid behavior logging method (see steps 3 and 4) are used to calculate and assign loyalty points to the user. FIG. 2 presents a scheme with all of the steps required for the cheating proof-mechanism. The mechanism works as following. Loyalty points are primarily assigned to the customer based on data gathered by the automatic behavior logging method trusted by the product manufacturer (see step 3). The point assignment function should give more points to the customer if his/her automatically recorded behavior is closer to the target behavior, and fewer points otherwise. In addition, the customer can earn extra points if s/he tells the truth in step 4, i.e. if his/her self-reported behavior is similar to the one automatically detected by the manufacturer's trusted behavior logging method (see step 3); otherwise, no extra points are accrued to the customer. This validation method provides the basis for the cheating-proof mechanism: in order to earn extra loyalty points, customers are “trained” to tell the truth with respect to their behavior even when it does not match the target behavior as defined by the manufacturer. That said, whenever the automatic method is not reliable thus requiring the loyalty program to trust the customer's self-reported behavior, it is likely that s/he will continue telling the truth aiming to get extra points.
6. Point redemption: When the target points defined by the program are met, the consumer can redeem those points for prizes (e.g., discount coupon, product, etc.). If the customer has not accumulated enough loyalty points to be redeemed for any given prize, s/he can continue participating in the loyalty program, collect further points, and finally redeem them in a later stage (cycle from steps 3 to 6).

A possible embodiment of the invention is described in the domain of electronics in which a smartphone manufacturer could benefit from the loyalty program proposed herein.

Considering a mother who purchases a smartphone but usually leaves it unattended at home, once in a while, her kids find the phone and play with it, which occasionally leads to unintentional drops. After a few months, the mother realizes the smartphone screen is not working properly and the battery life is getting shorter. She does not know how often her kids were letting the device fall and hence blames the smartphone maker. As a result, she decides not to buy any other smartphone from that particular brand anymore.

Loyalty Program:

Step 1: Definition of the customer's target behavior and the trusted automatic behavior logging method: A smartphone manufacturer wants to shape its customers behavior towards being more careful whenever handling their phones, as a significant amount of complains were reported regarding the built quality of the devices. The maker believes that users could benefit from its smartphones for longer if they were to reduce accidental falls, thus reducing the number of complaints registered by the customer support department, and hopefully increasing sales in the mid/long-term. Target behavior was defined as following: consumers who purchase smartphones from the given manufacturer should never let their phone fall. Two weeks was taken as the appropriate time between customer behavior reports. The manufacturer developed a simple mobile application to automatically log date and time for every instance of a detected smartphone fall based on data collected from the phone's internal clock and accelerometer sensor. By default, the application starts every time the phone is turned on. After running several tests, the manufacturer realized that this automatic behavior logging method is trustful as long as the smartphone is not exposed to high frequency electromagnetic interference. The maker then extended the application by also recording periods of detected electromagnetic interference, and using this information to compute a trustfulness index for every weekly behavior report. Values above 90% were considered to be reliable enough for most cases.

Step 2: Product purchase and agreement to participate in the loyalty program. The customer arrives at the electronics' store (vendor) and asks one of the attendants about a certain smartphone. The attendant explains a few technical details about the product and tells him/her about the maker's special loyalty program. According to the rules, consumers can accumulate points by not letting the device fall, and later redeem those points for prizes (e.g. discount coupons on other products of the same manufacturer). The only condition for joining the program is to let the smartphone maker continuously sense accelerometer data from the phone. The customer purchases the smartphone, leaves the store and heads back home. When turning the smartphone on for the first time and after setting up basic configurations (e.g., WiFi connection, 3G, etc.), the customer is asked whether s/he would like to know more about the special loyalty program. After confirming his/her interest, the program website is opened. The webpage presents details on the special loyalty program previously advertised by the electronics' store attendant. In addition, it also explains that if customers report the correct number of smartphone falls every week, they would receive extra loyalty points. The customer agrees with the terms and conditions of the loyalty program.

Step 3: Trusted automatic behavior logging. Whenever the customer uses his/her phone during the first week, the trusted mobile application—developed by the manufacturer—constantly senses accelerometer data and logs date and time for every instance of a detected smartphone fall. Additionally, periods of high frequency electromagnetic interferences are also recorded to compute the data's trustfulness index. By the end of the week, the mobile application detected one fall at 10:35 am of the third day, and a trustfulness index of 85% for the weekly data. This brief report is automatically sent to the loyalty program's dedicated server.

Step 4: Customer self-reported behavior logging. During the first week of usage, the customer is very careful whenever handling his/her new smartphone. Nevertheless, in one occasion his/her child played with the device and accidentally let it fall. By the end of the first week, the customer is presented with a single multiple-choice question, inquiring about how many times the smartphone fell on the ground in the past 7 days. The short quiz also informs the customer that, in case of reporting the correct number of falls, s/he would receive extra loyalty points. In order to avoid losing the bonus points, the customer decides to tell the truth and chooses the option associated to one fall.

Step 5: Cheating proof-mechanism for point assignment. The loyalty program server verifies that the automatic behavior logging method had a trustfulness index of only 85%, which is below the pre-established acceptable index of 90%. That said the cheating proof-mechanism uses the customer self-reported data instead to compute his/her loyalty points based on 1 fall during the week. Moreover, it accrues the user extra bonus points for reporting the “correct” number of falls. In fact, the system does not know that the customer reported the correct number of falls, but still gives him the extra points as an incentive to tell the truth in the next weeks.

Step 6: Point redemption. The customer can benefit from the loyalty program both in the short-term and in the long-term. Short-term benefits are not related to prizes, but rather to automatic logging of device falls and their respective approximate locations (using cell tower location data). This can be accomplished by sending SMS alerts to the customer whenever smartphone falls are detected and providing a direct link to the loyalty program website for checking the customer's smartphone-fall history. By inspecting typical days and locations of falls, customers can better understand what is going on with their phones in the absence of their surveillance. Finally, long-term benefits are related to redeeming points for—and not limited to—discounts in products from the same smartphone manufacturer.

The foregoing describes embodiments of the present invention and modifications, obvious to those skilled in the art can be made thereto, without departing from the scope of the present invention.

### REFERENCES

[1] Oliveira, R.; Cherubini, M.; Oliver, N. MoviPill: Improving medication compliance for elders using a mobile persuasive social game. In Proceedings of 12th ACM International Conference on Ubiquitous Computing (ACM Ubicomp). Copenhagen, Denmark: ACM, 251-260, 2010.

[2] HealthPrize rewards you for taking your medication. Available at: www.healthprize.com. Accessed on: Aug 2012.

1. Method for a cheating-proof user experience based loyalty program, comprising assigning loyalty points to users complying with a target behavior when using a device with at least one electronic component, the method comprising the following steps;
logging by a user a first set of user self-reported behavior data relating to the use of said device within a period of time;
logging by said device a second set of automatically recorded user behavior data relating to said same period of time obtained from an interaction with said device, and assigning a trustfulness index to said data recorded by said automatic behavior data recording; and
a) when said trustfulness index is lower than a predetermined value, generating a first comparison value comparing said self-reported behavior to a predefined user target behavior data of said device within said period of time, and assigning loyalty points to the user according to said first comparison value; and
b) when said trustfulness index is equal or higher than said predetermined value, generating a second comparison value comparing said second set of automatically recorded user behavior data to said predefined user target behavior data, and assigning loyalty points to the user according to said second comparison value; and generating a third comparison value related to comparing said first set of user self-reported behavior data and said second set of automatically recorded user behavior data, and assigning extra loyalty points to said user according to said third comparison value.

2. Method according to claim 1, wherein the step of assigning loyalty points is carried out by adding and/or deducting said loyalty points, and the step of assigning extra loyalty points is carried out by adding and /or deducting said extra loyalty points.

3. Method according to claim 1, wherein:
if the absolute value of the third comparison value is greater than a cheating-detection predetermined value, no extra loyalty points are added to said user; and
if the absolute value of the third comparison value is lower than or equal to a cheating-detection predetermined value, extra loyalty points are added to said user.

4. Method according to claim 1, wherein said second set of automatically recorded user behavior data is kept unknown to said user.

5. Method according to claim 4, wherein said automatic logging trustfulness index is kept unknown to said user.

6. Method according to claim 1, wherein said user defines a preferred frequency reporting of said user self-reported behavior data.

7. Method according to claim 1, wherein in said electronic component is at least any of a thermometer, an accelerometer, a magnetometer, a global positioning system, a heart rate monitor, a mobile device and/or any monitoring device.

8. Method according to claim 1, wherein said user self-reported behavior data is provided to a server by using said device or any other computing device through a communication network and/or through any mobile messaging technology.

9. Method according to claim 8, wherein the interaction between said server and said electronic component is done through a communication network and/or through any mobile messaging technology.

10. Method according to claim 9, comprising storing said automatically recorded user behavior data in a memory of said device and/or in any auxiliary device prior to performing said interaction.

11. Method according to claim 1, further comprising providing said user with a prize and/or a good if their assigned loyalty points are over a target loyalty points.

12. A computer program product for assigning loyalty points to users complying with a predefined target behavior data when using a device with an electronic component adapted to assigning a trustfulness index to a set of automatically recorded user behavior data relating to a period of time obtained from an interaction with said device, said computer program product comprising:
software code that is configured to, when said trustfulness index is lower than a predetermined value, generate a first comparison value comparing a self-reported behavior of said user to a predefined target behavior data defined by a manufacturer of said device and assigning loyalty points to the user according to said first comparison value; and
software code that is configured to, when said trustfulness index is equal or higher than said predetermined value, generate a second comparison value comparing said second set of automatically recorded user behavior data to said predefined target behavior data and assigning loyalty points to the user according to said second comparison value; and generate a third comparison value related to comparing said second set of automatically recorded user behavior data and said first set of user self-reported behavior data, and assigning extra loyalty points to said user according to said third comparison value.

13. A computer program product according to claim 12, further comprising:
software code that is configured to, when the absolute value of the third comparison value is greater than a cheating-detection predetermined value, add no extra loyalty points to said user; and when the absolute value of the third comparison value is lower than or equal to a cheating-detection predetermined value, add extra loyalty points to said user.
